(19) United States
(12) Patent Application Publication
(10) Pub. No.: US 2024/0393104 A1
(43) Pub. Date: Nov. 28, 2024

(54) SURFACE SHAPE MEASURING DEVICE AND SURFACE SHAPE MEASUREMENT METHOD

(71) Applicant: Tokyo Seimitsu Co., Ltd., Tokyo (JP)

(72) Inventors: Yoshiyuki KAWATA, Tsuchiura-city (JP); Katsufumi MORIYAMA, Tsuchiura-city (JP); Hideki MORII, Tsuchiura-city (JP)

(73) Assignee: Tokyo Seimitsu Co., Ltd., Tokyo (JP)

(21) Appl. No.: 18/795,866

(22) Filed: Aug. 6, 2024

Related U.S. Application Data
(63) Continuation of application No. PCT/JP2023/003196, filed on Feb. 1, 2023.

(30) Foreign Application Priority Data
Feb. 7, 2022 (JP) 2022-017254
Feb. 7, 2022 (JP) 2022-017255

(51) Int. Cl. G01B 11/24; G01D 5/347; H04N 23/695

(52) U.S. Cl. CPC G01B 11/2441; G01D 5/34746; H04N 23/695

(57) ABSTRACT

A surface shape measuring device includes a camera that captures the observation image acquired by the optical head, a drive unit that causes the optical head to scan relatively in a scanning direction perpendicular to the measurement target, an encoder for detecting a position of the optical head in the scanning direction with respect to the measurement target, an imaging instructing unit that instructs the camera to capture the observation image based on a position signal output from the encoder for each predetermined interval, a frame dropping occurrence rate calculating unit that calculates a frame dropping occurrence rate indicating an occurrence rate of frame dropping of the camera, and a measurement condition setting unit that sets a measurement condition for measuring a surface shape of the measurement target based on the frame dropping occurrence rate.

### CROSS-REFERENCE TO RELATED APPLICATIONS

The present application is a Continuation of PCT International Application No. PCT/JP2023/003196 filed on Feb. 1, 2023 claiming priorities under 35 U.S.C § 119 (a) to Japanese Patent Application No. 2022-017254 filed on Feb. 7, 2022, and Japanese Patent Application No. 2022-017255 filed on Feb. 7, 2022. Each of the above applications is hereby expressly incorporated by reference, in their entirety, into the present application.

### BACKGROUND OF THE INVENTION

### Field of the Invention

The present invention relates to a surface shape measuring device and a surface shape measurement method.

### Description of the Related Art

A measurement method for measuring a three-dimensional shape of a surface to be measured of a measurement target using a microscope scanning-type surface shape measuring device employing a white light interference scheme, a focus variation scheme, or the like, is known (see Patent Literature 1 and Patent Literature 2). In measuring a three-dimensional shape of a surface to be measured, such a scanning-type surface shape captures an image of the surface to be measured using a camera having an microscope for each fixed pitch while scanning the surface along a scanning direction, and calculates height information for each pixel or calculates a focusing degree (focus position of the microscope) for each pixel of each observation image, based on the observation image for each pitch and information from a scale.

### CITATION LIST

Patent Literature 1: Japanese Patent Application Laid-Open No. 2016-90520
Patent Literature 2: Japanese Patent Application Laid-Open No. 2016-99213

### SUMMARY OF THE INVENTION

In a scanning-type surface shape measuring device, if vibration occurs during scanning, a relative positional relationship between a microscope and a measurement target is displaced, which becomes a factor of a measurement error. Further, a measurement error occurs as a result of frame drop in a camera due to vibration of a scale, or the like.

The present invention has been made in view of such circumstances, and aims to provide a surface shape measuring device and a surface shape measurement method capable of suppressing influence of vibration occurring during measurement to improve measurement accuracy.

According to a first aspect, a surface shape measuring device that acquires an observation image of a measurement target while causing an optical head to scan relatively to the measurement target in a direction perpendicular to the measurement target, includes: a camera configured to capture the observation image acquired by the optical head; a drive unit configured to cause the optical head to scan relatively to the measurement target in a scanning direction perpendicular to the measurement target; an encoder configured to detect a position of the optical head in the scanning direction with respect to the measurement target; an imaging instructing unit configured to instruct the camera to capture the observation image based on a position signal output from the encoder for each predetermined interval; a frame dropping occurrence rate calculating unit configured to calculate a frame dropping occurrence rate indicating an occurrence rate of frame dropping of the camera; and a measurement condition setting unit configured to set a measurement condition for measuring a surface shape of the measurement target based on the frame dropping occurrence rate.

Preferably, the surface shape measuring device according to the first aspect further includes a stage a stage configured to move the measurement target relatively to the optical head, and the frame dropping occurrence rate calculating unit calculates the frame dropping occurrence rate indicating the occurrence rate of frame dropping of the camera for each position of the stage, and the measurement condition setting unit sets the measurement condition for measuring the surface shape of the measurement target for each position of the stage based on the frame dropping occurrence rate.

Preferably, in the surface shape measuring device, the measurement condition setting unit sets a range of a field of view of the camera as the measurement condition.

Preferably, in the surface shape measuring device, the measurement condition setting unit sets a scanning speed of the optical head with respect to the measurement target as the measurement condition.

Preferably, in the surface shape measuring device, the measurement condition setting unit determines whether or not the measurement condition is required to be changed based on a result of comparing the frame dropping occurrence rate with a frame dropping occurrence rate threshold.

Preferably, in the surface shape measuring device, in a case where it is determined that the measurement condition is required to be changed, the measurement condition setting unit changes the measurement condition so that the frame dropping occurrence rate becomes less than the frame dropping occurrence rate threshold.

Preferably, in the surface shape measuring device, the measurement condition setting unit can set both the range of the field of view of the camera and the scanning speed of the optical head with respect to the measurement target as the measurement condition, and in a case where it is determined that the measurement condition is required to be changed, changes the range of the field of the view of the camera in preference to the scanning speed of the optical head so that the frame dropping occurrence rate becomes equal to or less than the frame dropping occurrence rate threshold.

Preferably, in the surface shape measuring device, in a case where the frame dropping occurrence rate is denoted as FDR, the number of frames of the observation image actually captured by the camera is denoted as N, and an estimated number of frames of the observation image to be originally captured by the camera based on the position signal is denoted as M, the frame dropping occurrence rate calculating unit calculates the frame dropping occurrence rate using the following expression, FDR=1−N/M.

Preferably, in the surface shape measuring device, the optical head is a white light interferometry microscope.

According to a second aspect, a surface shape measurement method for measuring a surface shape by a surface shape measuring device including a camera configured to capture an observation image of a measurement target acquired by an optical head, a drive unit configured to cause the optical head to scan relatively to the measurement target in a scanning direction perpendicular to the measurement target, an encoder configured to detect a position of the optical head in the scanning direction with respect to the measurement target, an imaging instructing unit configured to instruct the camera to capture the observation image based on a position signal output from the encoder for each predetermined interval, includes a frame dropping occurrence rate calculating step of calculating a frame dropping occurrence rate indicating an occurrence rate of frame dropping of the camera, and a measurement condition setting step of setting a measurement condition for measuring the surface shape of the measurement target based on the frame dropping occurrence rate.

Preferably, in the surface shape measurement method according to the second aspect, in the frame dropping occurrence rate calculating step, the frame dropping occurrence rate indicating the occurrence rate of frame dropping of the camera is calculated for each position of a stage configured to move the measurement target relatively to the optical head, and in the measurement condition setting step, the measurement condition for measuring the surface shape of the measurement target is set for each position of the stage based on the frame dropping occurrence rate.

Preferably, in the measurement condition setting step, a range of a field of view of the camera is set as the measurement condition.

Preferably, in the measurement condition setting step, a scanning speed of the optical head with respect to the measurement target is set as the measurement condition.

Preferably, in the measurement condition setting step, whether or not the measurement condition is required to be changed is determined based on a result of comparing the frame dropping occurrence rate with a frame dropping occurrence rate threshold.

Preferably, in the measurement condition setting step, in a case where it is determined that the measurement condition is required to be changed, the measurement condition is changed so that the frame dropping occurrence rate becomes less than the frame dropping occurrence rate threshold.

Preferably, in the measurement condition setting step, both the range of the field of view of the camera and the scanning speed of the optical head with respect to the measurement target can be set as the measurement condition, and in a case where it is determined that the measurement condition is required to be changed, the range of the field of view of the camera is changed in preference to the scanning speed of the optical head so that the frame dropping occurrence rate becomes equal to or less than the frame dropping occurrence rate threshold.

Preferably, in a case where the frame dropping occurrence rate is denoted as FDR, the number of frames of the observation image actually captured by the camera is denoted as N, and an estimated number of frames of the observation image to be originally captured by the camera based on the position signal is denoted as M, in the frame dropping occurrence rate calculating step, the frame dropping occurrence rate is calculated using the following expression, FDR=1−N/M.

According to the present invention, it is possible to improve measurement accuracy by suppressing influence of vibration occurring during measurement.

### BRIEF DESCRIPTION OF THE DRAWINGS

FIG. 1 is a schematic configuration diagram of a surface shape measuring device.

FIG. 2 is a block diagram of the surface shape measuring device.

FIG. 3 is a diagram for explaining calculation of a three-dimensional shape of a measurement target by the surface shape measuring device.

FIG. 4 is a diagram for explaining a range of a field of view.

FIG. 5 is a flowchart indicating setting of a measurement condition in a pre-adjustment mode according to a first embodiment.

FIG. 6 is a flowchart indicating a measurement mode according to the first embodiment.

FIG. 7 is a flowchart indicating a measurement mode according to a second embodiment.

FIG. 8 is a diagram for explaining measurement of a plurality of measurement targets in a third embodiment.

FIG. 9 is a flowchart indicating setting of a measurement condition in a pre-adjustment mode according to the third embodiment.

FIG. 10 is a flowchart indicating a measurement mode according to the third embodiment.

### DESCRIPTION OF THE EMBODIMENTS

Preferred embodiments of the present invention will be described below in accordance with the accompanying drawings.

### <Configuration of Surface Shape Measuring Device>

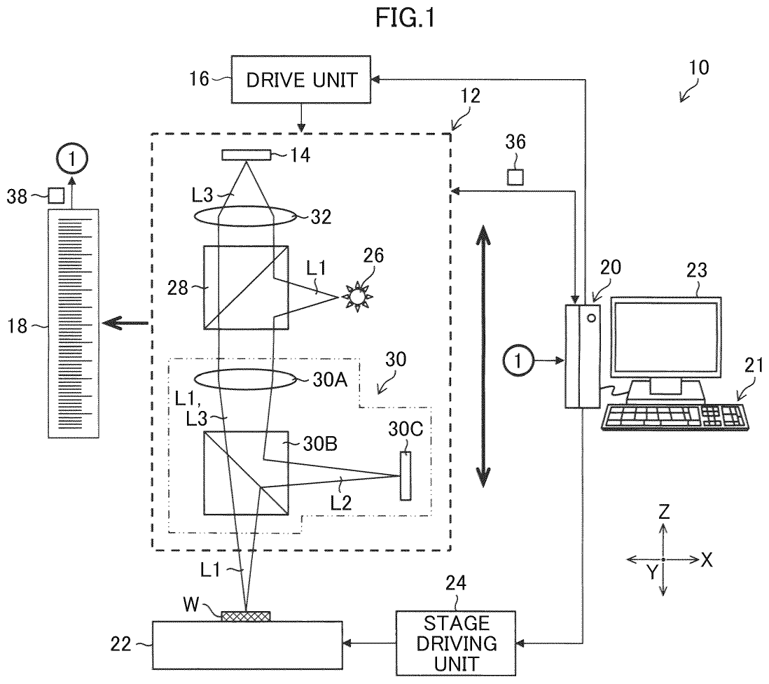

FIG. 1 is a schematic configuration diagram of a surface shape measuring device 10 that measures a surface shape of a measurement target W. A configuration of the surface shape measuring device 10 illustrated in FIG. 1 is common among a first embodiment to a third embodiment which will be described later. Note that X and Y directions among X, Y and Z directions perpendicular to each other in the drawing are horizontal directions, and the Z direction is a vertical direction (perpendicular direction).

As illustrated in FIG. 1, the surface shape measuring device 10 includes an optical head 12, a drive unit 16, an encoder 18 and a control device 20 for measuring a three-dimensional shape (surface shape) of a surface to be measured of the measurement target W. The surface shape measuring device 10 illustrated in FIG. 1 includes a stage 22 and a stage driving unit 24. Note that there is a case where the optical head 12, the camera 14, the drive unit 16 and the encoder 18 may be collectively referred to as an optical head unit.

As illustrated in FIG. 1, the optical head 12 includes a Michelson-type white light interferometry microscope.

The optical head 12 includes a camera 14, a light source unit 26, a beam splitter 28, an interference objective lens 30 and an imaging lens 32.

The interference objective lens 30, the beam splitter 28, the imaging lens 32 and the camera 14 are arranged in this order from the measurement target W to the upper side along the Z direction. Further, the light source unit 26 is arranged at a position facing the beam splitter 28 in the X direction (or can be the Y direction).

The light source unit 26 emits white light (low-coherence light with low coherence) of a parallel light flux toward the beam splitter 28 as measurement light L1 under control of the control device 20. While not illustrated, the light source unit 26 includes: a light source capable of emitting the measurement light L1, such as a light-emitting diode, a semiconductor laser, a halogen lamp and a high-brightness discharge lamp; and a collector lens that converts the measurement light L1 emitted from the light source into a parallel light flux.

As the beam splitter 28, for example, a half mirror is used. The beam splitter 28 reflects part of the measurement light L1 incident from the light source unit 26 toward the interference objective lens 30 on a lower side in the Z direction. Further, the beam splitter 28 allows part of multiplexed light L3 (described later) incident from the interference objective lens 30 to pass upward in the Z direction, so as to output the multiplexed light L3 toward the imaging lens 32.

The interference objective lens 30, which is a Michelson-type lens, includes an objective lens 30A, a beam splitter 30B and a reference surface 30C. The beam splitter 30B and the objective lens 30A are arranged in this order from the measurement target W to the upper side along the Z direction. Further, the reference surface 30C is arranged at a position facing the beam splitter 30B in the X direction (or can be the Y direction).

The objective lens 30A has a focusing function and causes the measurement light L1 incident from the beam splitter 28 to focus on the measurement target W through the beam splitter 30B.

As the beam splitter 30B, for example, a half mirror is used. The beam splitter 30B splits part of the measurement light L1 incident from the objective lens 30A as reference light L2, and reflects the reference light L2 toward the reference surface 30C. Further, the beam splitter 30B allows remaining part of the measurement light L1 to pass therethrough toward the measurement target W. The measurement light L1 that has passed through the beam splitter 30B is radiated on the measurement target W, and then reflected by the measurement target W and returns to the beam splitter 30B.

As the reference surface 30C, for example, a reflecting mirror is used. The reference surface 30C reflects the reference light L2 incident from the beam splitter 30B toward the beam splitter 30B. A position of the reference surface 30C in the X direction can be manually adjusted using a position adjustment mechanism (not illustrated). This enables adjustment of an optical path length of the reference light L2 between the beam splitter 30B and the reference surface 30C. The reference light path length is adjusted so as to be equal (including roughly equal) to an optical path length of the measurement light L1 between the beam splitter 30B and the measurement target W.

The beam splitter 30B generates the multiplexed light L3 of the measurement light L1 returning from the measurement target W and the reference light L2 returning from the reference surface 30C, and emits the multiplexed light L3 toward the objective lens 30A on the upper side in the Z direction. The multiplexed light L3 passes through the objective lens 30A and the beam splitter 28 and is incident on the imaging lens 32. In a case of the white light interferometry microscope, the multiplexed light L3 is interference light having interference fringes.

The imaging lens 32 forms an image of the multiplexed light L3 incident from the beam splitter 28 on an imaging surface (not illustrated) of the camera 14. Specifically, the imaging lens 32 forms an image of a point on a focal plane of the objective lens 30A, as an image point on the imaging surface of the camera 14.

The camera 14 includes a charge coupled device (CCD)-type or a complementary metal oxide semiconductor (CMOS)-type imaging element (not illustrated). The camera 14 captures an image of the multiplexed light L3 formed on the imaging surface by the imaging lens 32 as an observation image, and outputs the captured observation image 36. Here, the observation image 36 includes interference fringes.

The drive unit 16 includes a publicly known linear motor or motor drive mechanism. The drive unit 16 holds the optical head 12 so as to be able to freely scan relatively to the measurement target W in the Z direction that is a vertical scanning direction (optical axis direction of the optical head 12). The drive unit 16 moves the optical head 12 relatively to the measurement target W at a set scanning speed and in a set range in the scanning direction under control of the control device 20.

Note that the drive unit 16 is just required to be able to cause the optical head 12 to scan in the scanning direction relatively to the measurement target W. For example, the drive unit 16 may cause the stage 22 that supports the measurement target W to scan in the scanning direction.

The stage 22 has a stage surface which supports the measurement target W thereon. The stage surface includes a flat surface substantially parallel to the X direction and the Y direction. The stage driving unit 24 includes a publicly known linear motor or motor drive mechanism and horizontally moves the stage 22 relatively to the optical head 12 under control of the control device 20 in a plane (the X direction and the Y direction) perpendicular to the scanning direction.

Note that the stage driving unit 24 is just required to be able to move the stage 22 in the X direction and the Y direction relatively to the optical head 12. For example, the stage driving unit 24 may move the optical head 12 in the X direction and the Y direction with respect to the stage 22 that supports the measurement target W.

The encoder 18 is a position detection sensor that detects a position of the optical head 12 relative to the measurement target W in the scanning direction. For example, an optical linear encoder (which will be also referred to as a scale) may be used as the encoder 18. The optical linear encoder includes, for example, a linear scale on which slits are formed at regular intervals, and a light receiving element and a light emitting element arranged to face each other across the linear scale. The encoder 18 repeatedly detects the position of the optical head 12 in the scanning direction (position in the Z direction) and repeatedly outputs a position signal 38 including position information indicating the position in the scanning direction (position in the Z direction) to the control device 20.

The control device 20 comprehensively controls operation of the surface shape measuring device 10 such as switching between adjustment before the measurement target W is measured (pre-adjustment mode) and measurement of the measurement target W (measurement mode), setting of measurement conditions in each mode, and calculation of a three-dimensional shape in the measurement mode in accordance with input operation to an operating unit 21. A display unit 23 displays various kinds of information under control of the control device 20.

The control device 20 includes an arithmetic circuit that includes various kinds of processors (processors), memories, and the like. The various kinds of processors include a central processing unit (CPU), a graphics processing unit (GPU), an application specific integrated circuit (ASIC), a programmable logical device [for example, a simple programmable logic device (SPLD), a complex programmable logic device (CPLD) and a field programmable gate array (FPGA)], and the like. Note that various kinds of functions of the control device 20 may be implemented by one processor or may be implemented by processors of the same type or different types.

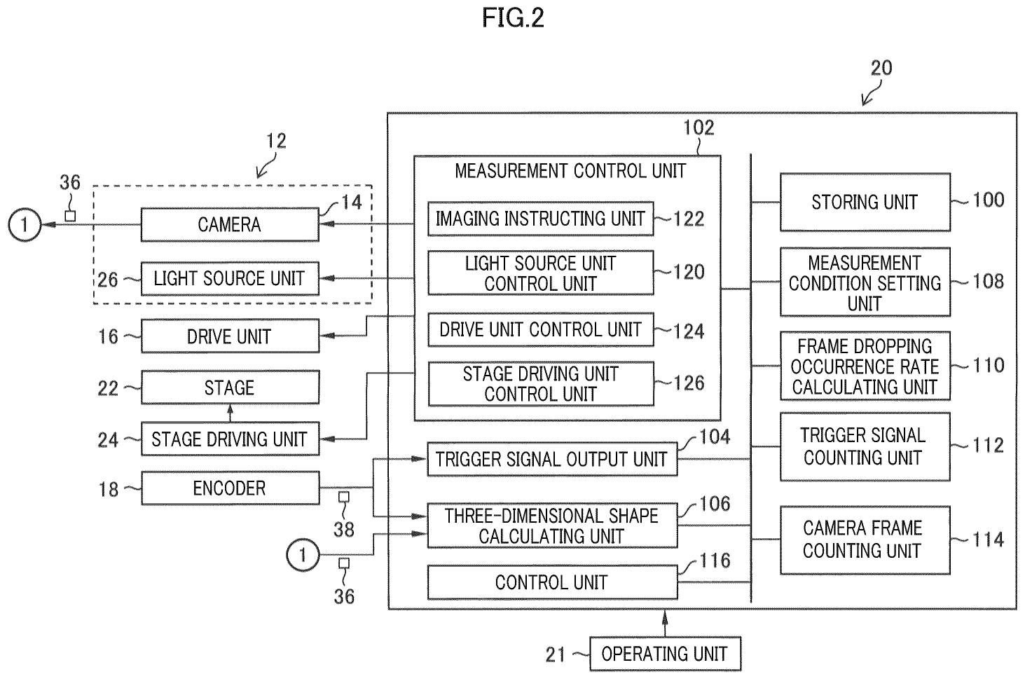

FIG. 2 is a functional block diagram of the control device 20. As illustrated in FIG. 2, the camera 14 and the light source unit 26 of the optical head 12, the drive unit 16, the encoder 18, the stage driving unit 24 and the operating unit 21 are connected to the control device 20.

As illustrated in FIG. 2, the control device 20 includes a storing unit 100, a measurement control unit 102, a trigger signal output unit 104, a three-dimensional shape calculating unit 106, a measurement condition setting unit 108, a frame dropping occurrence rate calculating unit 110, a trigger signal counting unit 112, a camera frame counting unit 114, and a control unit 116. The control device 20 executes a control program (not illustrated) read out from the storing unit 100 to implement respective functions and execute processing. The control unit 116 controls the whole processing of the control device 20.

As illustrated in FIG. 2, the measurement control unit 102 includes a light source unit control unit 120, an imaging instructing unit 122, a drive unit control unit 124 and a stage driving unit control unit 126. The control unit 116 controls the light source unit 26, the camera 14, the drive unit 16 and the stage driving unit 24.

The light source unit control unit 120 causes the light source unit 26 to start emission of the measurement light L1. The drive unit control unit 124 controls the drive unit 16 to cause the optical head 12 to scan in the scanning direction at the set scanning speed and within the set scanning range.

While the drive unit 16 causes the optical head 12 to scan in the scanning direction, the position signal 38 is output from the encoder 18, and the position signal 38 is supplied to the trigger signal output unit 104. The trigger signal output unit 104 outputs a trigger signal for each predetermined interval based on the position signal 38 output from the encoder 18.

The imaging instructing unit 122 instructs the camera 14 to capture an observation image by the trigger signal output from the trigger signal output unit 104 for each predetermined interval.

The camera 14 acquires observation images 36 of the measurement target W for each predetermined interval described above (that is, a sampling interval) within the scanning range set by an operator via the operating unit 21, based on the trigger signal output from the trigger signal output unit 104. The observation images 36 acquired by the camera 14 for each predetermined interval (sampling interval) are output to the control device 20, and each observation image 36 is associated with the position signal 38 (including the position information indicating the position in the Z direction) at the time when the observation image 36 is acquired. The three-dimensional shape calculating unit 106 calculates a surface shape of the measurement target W based on the observation image 36 and the position signal 38. The observation image 36 and position signal 38 which are associated with each other, may be stored in the storing unit 100. The three-dimensional shape calculating unit 106 may calculate the surface shape of the measurement target W based on the observation image 36 and the position signal 38 stored in the storing unit 100.

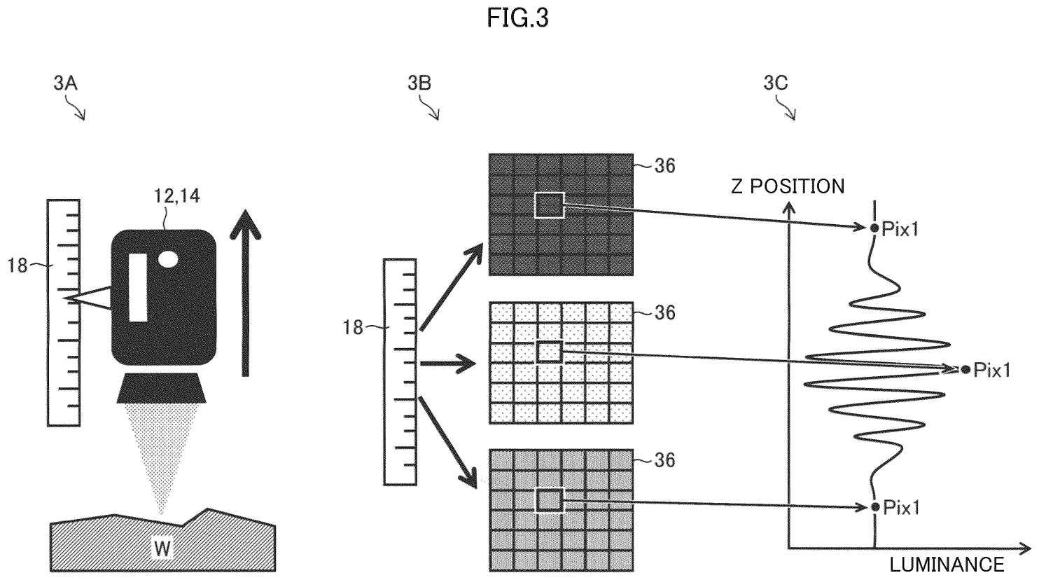

FIG. 3 is an explanatory diagram for explaining calculation of the three-dimensional shape of the measurement target W by the surface shape measuring device 10. A reference numeral 3A in FIG. 3 designates a schematic diagram illustrating the scanning direction of the optical head 12. A reference numeral 3B in FIG. 3 designates the observation images acquired by the camera 14 at respective positions in the scanning direction while raising the optical head 12 in the scanning direction from a position near the measurement target W. A reference numeral 3C in FIG. 3 designates a diagram illustrating an example of a correlation between the position in the Z direction (height) and luminance for each pixel (pixel), and an interference fringe curve.

The three-dimensional shape calculating unit 106 acquires, from the camera 14, the observation image 36 of the measurement target W captured for each sampling interval in the range of the field of view of the camera 14 while the optical head 12 is caused to scan in the scanning direction.

Then, as indicated with the reference numeral 3B and the reference numeral 3C in FIG. 3, the three-dimensional shape calculating unit 106 detects a luminance value for each pixel of each observation image 36 in which interference fringes are generated. Then, the three-dimensional shape calculating unit 106 compares luminance values (see a reference numeral Pix1) for each pixel on the same coordinate in the respective observation images 36 (imaging elements of the camera 14). The three-dimensional shape calculating unit 106 determines a position in the Z direction at which the luminance value becomes maximum for each pixel on the same coordinate in the respective observation images 36, to calculate height information of the measurement target W for each pixel on the same coordinate.

A relationship between the range of the field of view of the camera 14 which is one of the measurement conditions set in the surface shape measuring device 10, and a maximum frame rate will be described next.

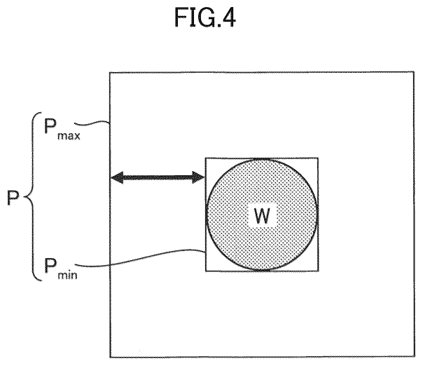

FIG. 4 explains the range of the field of view of the camera 14 which is one of the measurement conditions. FIG. 4 is a diagram of the measurement target W observed from a side of the camera 14 along the scanning direction (Z direction). Typically, the range of the field of view of the camera 14 is a range in which the measurement target W can be measured at a time. Thus, if the range of the field of view of the camera 14 is made smaller, the entire target region to be measured of the measurement target W does not fall within the range of the field of view of the camera 14, which results in requiring a plurality of times of measurement and may degrade measurement efficiency.

Thus, as illustrated in FIG. 4, in terms of the measurement efficiency, the range of the field of view of the camera 14 preferably includes the region to be measured of the measurement target W and is preferably a maximum range of the field of view Pₘₐₓ.

On the other hand, while a maximum frame rate F_{c} [fps] of the camera 14 is a maximum value of the number of frames (captured images) that can be captured by the camera 14 for one second, there is an inverse relationship between the maximum frame rate F_{c} of the camera 14 and the range of the field of view P of the camera 14 as indicated in the following expression (1).

$${F}_{c} \approx A / P ( A : proportional constant ) \qquad ( 1 )$$

In other words, if the range of the field of view P of the camera 14 is made larger, while the measurement efficiency can be improved as a result of the number of times of measurement being reduced, the maximum frame rate F_{c} of the camera 14 becomes smaller. Thus, as can be understood from expression (3) and expression (4), which will be described later, frame dropping is more likely to occur due to influence of vibration, which may cause degradation in the measurement accuracy. On the other hand, if the range of the field of view P of the camera 14 is made smaller, while frame dropping is less likely to occur than in the former case, and the measurement accuracy can be improved as a result of the maximum frame rate F. of the camera 14 becoming greater. However, the number of times of measurement increases as a result of the range of the field of view P being made smaller, which causes degradation in the measurement efficiency. Thus, to achieve both the measurement efficiency and the measurement accuracy, it is important to appropriately set the range of the field of view P of the camera 14. Note that in terms of the measurement efficiency, the range of the field of view P of the camera 14 is preferably set in a minimum range of the field of view Pₘᵢₙ at least including the measurement target W. The range of the field of view P of the camera 14 is set between the minimum range of the field of view Pₘᵢₙ and a maximum range of the field of view Pₘₐₓ as indicated with an arrow.

Conditions in which frame dropping of the camera 14 occurs will be described next. As described above, the observation image is captured by the camera 14 based on the trigger signal output from the trigger signal output unit 104 for each predetermined interval (that is, the position signal 38 output from the encoder 18 for each predetermined interval) while the optical head 12 is caused to scan in the scanning direction. In this event, the imaging interval of the observation image captured by the camera 14 is referred to as a sampling interval. Here, in a case where the scanning speed of the optical head 12 relative to the measurement target W is denoted as V_{c} [nm/s], the sampling interval of the camera 14 is denoted as D_{c} [nm], and the sampling frequency of the camera 14 is denoted as Fₛ [Hz], there is a relationship of the following expression (2).

$${F}_{s} = {V}_{c} / {D}_{c} \qquad ( 2 )$$

The sampling frequency Fₛ of the camera 14 is equal to the number of observation images captured for one second in a case where the camera 14 captures the observation image based on the trigger signal output from the trigger signal output unit 104.

Thus, in a case where the maximum frame rate F_{c} of the camera 14 and the sampling frequency Fₛ satisfy a relationship of the following expression (3) (in a case where the sampling frequency Fₛ is greater than the maximum frame rate F_{c}), if an instruction is given to capture an image at a speed exceeding the maximum frame rate F_{c}, the number of frames exceeding the maximum frame rate F_{c} is ignored to cause so-called frame dropping. Occurrence of frame dropping may cause degradation of the measurement accuracy. Particularly, if the scanning speed V_{c} becomes higher, the sampling frequency Fₛ of the camera 14 increases as indicated in expression (2), and thus, frame dropping is more likely to occur.

$${F}_{c} < {F}_{s} \qquad ( 3 )$$

It is therefore necessary to set the sampling frequency Fₛ of the camera 14 so as not to satisfy expression (3) (that is, so that the sampling frequency Fₛ becomes equal to or less than the maximum frame rate F_{c}).

However, vibration may occur depending on an environment where the surface shape measuring device 10 is installed, and there is a case where the vibration may affect measurement by the surface shape measuring device 10. For example, a fan attached to the surface shape measuring device 10, vibration from a floor, a motor of a work conveyance system, or the like, become a vibration source. If, for example, vibration occurs during scanning, in the surface shape measuring device 10, a relative position between the measurement target W and the optical head 12 is displaced due to vibration of the measurement target W, which may cause a measurement error due to the displacement. Further, a measurement error may occur as a result of frame dropping of the camera 14 due to vibration of the optical head unit. In this manner, vibration may become an element to increase the scanning speed of the optical head 12, and thus, in a case where the scanning speed of the optical head 12 is too high, frame dropping is likely to occur. Here, if a vibration frequency due to vibration occurring during measurement by the surface shape measuring device 10 is denoted as Fₘ [Hz], in a case where the maximum frame rate F_{c} of the camera 14, the sampling frequency Fₛ and the vibration frequency Fₘ satisfy the following expression (4), frame dropping occurs. Note that it is assumed that the vibration frequency Fₘ has the same level of amplitude strength as the level of amplitude strength of the sampling interval of the camera 14.

$${F}_{c} < {F}_{s} + {F}_{m} \qquad ( 4 )$$

Thus, in order to suppress degradation of the measurement accuracy due to frame dropping even if the vibration as described above occurs during measurement by the surface shape measuring device 10, it is necessary to set the sampling frequency Fₛ of the camera 14 in view of the vibration frequency Fₘ so as not to satisfy expression (4).

As can be understood from expression (2) and expression (4), in a case where the scanning speed V_{c} is high (the sampling frequency Fₛ becomes high), or in a case where the range of the field of view P is large (the maximum frame rate F_{c} becomes small), frame dropping is likely to occur by influence of vibration during measurement. In the present embodiment, to suppress influence of vibration during measurement in a pre-adjustment mode and a measurement mode which will be described later, the scanning speed V_{c} or the range of the field of view P that is the measurement condition can be set to a desired value. Note that frame dropping is likely to occur also in a case where the sampling interval D_{c} of the camera 14 is small (the sampling frequency Fₛ becomes high) or in a case where the vibration frequency Fₘ due to the vibration is high.

However, it is difficult to directly measure the vibration frequency Fₘ due to vibration occurring during measurement, and thus, influence of the vibration cannot be sufficiently suppressed, and there is a limit on improvement of the measurement accuracy.

Thus, to solve the above-described problem, the inventors have introduced an idea of a frame dropping occurrence rate, and set measurement conditions to the surface shape measuring device 10 based on the frame dropping occurrence rate so as to suppress influence of the vibration, thereby improving measurement accuracy.

A method for calculating the frame dropping occurrence rate will be described below. The frame dropping occurrence rate is calculated from an estimated number of frames to be measured and the number of frames actually measured.

The estimated number of frames to be measured is the number of frames (the number of observation images) to be originally acquired by the camera 14 in a case where the camera 14 performs imaging operation based on the trigger signal output from the trigger signal output unit 104 for each predetermined interval assuming that frame dropping does not occur. In a case where the estimated number of frames to be measured is denoted as M, the sampling frequency of the camera 14 is denoted as Fₛ [fps], the sampling interval is denoted as D_{c} [nm], a scanning range of the optical head 12 is denoted as D_{R} [nm], the scanning speed is denoted as V_{c} [nm/s], and a scanning period is denoted as t [s], the estimated number of frames to be measured M may be obtained from the following expression (5).

$$M = {F}_{s} \times t = {V}_{c} / {D}_{c} \times {D}_{R} / {V}_{c} = {D}_{R} / {D}_{c} \qquad ( 5 )$$

The number of measured frames is the number of frames (the number of observation images) actually captured by the camera 14 during measurement. In a case where the number of measured frames is denoted as N, and the frame dropping occurrence rate is denoted as FDR, the frame dropping occurrence rate FDR may be calculated from the following expression (6).

$$F D R = 1 - N / M \qquad ( 6 )$$

In expression (6), the frame dropping occurrence rate FDR can be calculated by obtaining a ratio of the captured observation images by dividing the number of measured frames N by the estimated number of frames to be measured M, and subtracting the ratio from 1. In a case where FDR>0, it means that frame dropping occurs, and the greater FDR's value means that more frames are dropped. Vibration occurring in the optical head unit is indirectly detected by calculating the frame dropping occurrence rate FDR.

To make it easier to detect vibration of the measurement target W, a mass of the white light interferometry microscope (optical head unit) is preferably designed smaller than a mass of a base to which the optical head unit is attached. A natural frequency of the white light interferometry microscope may be made higher than a natural frequency of the basc.

In each embodiment, as will be described later, because the measurement conditions of the surface shape measuring device 10 are set based on the frame dropping occurrence rate FDR, it is possible to suppress influence of vibration occurring during measurement and improve the measurement accuracy.

### First Embodiment

### <Pre-Adjustment Mode According to First Embodiment>

One example of setting of the measurement conditions in a pre-adjustment mode using the frame dropping occurrence rate will be described next. In the pre-adjustment mode, a frame dropping occurrence rate threshold Th is set for the frame dropping occurrence rate FDR, the frame dropping occurrence rate FDR is compared with the frame dropping occurrence rate threshold Th, and it is determined whether or not the measurement conditions are required to be changed. In a case where it is determined that the measurement conditions are not required to be changed, measurement conditions at the time when the frame dropping occurrence rate FDR is calculated are set as the measurement conditions to be used in the measurement mode.

On the other hand, in a case where it is determined that the measurement conditions are required to be changed, the frame dropping occurrence rate FDR is calculated, while changing the measurement conditions at the time when the frame dropping occurrence rate FDR is calculated. The frame dropping occurrence rate FDR is repeatedly calculated while changing the measurement conditions until it is determined that the measurement conditions are not required to be changed. Finally, measurement conditions with which the frame dropping occurrence rate FDR is calculated at the time when it is determined that the measurement conditions are not required to be changed are set as the measurement conditions to be used in the measurement mode.

As described above, in a case where the scanning speed V_{c} is high, or in a case where the range of the field of view P is large, frame dropping is likely to occur. Thus, both the range of the field of view P and the scanning speed V_{c} are set as the measurement conditions in the pre-adjustment mode.

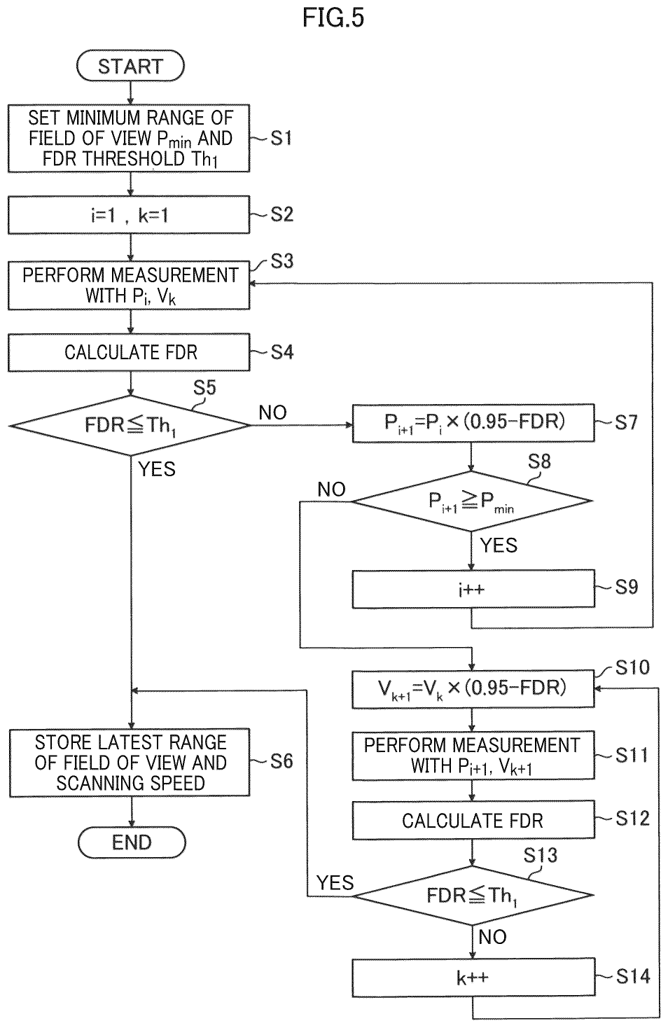

FIG. 5 is a flowchart indicating setting of the measurement conditions in the pre-adjustment mode according to the first embodiment. In the pre-adjustment mode, the surface shape measuring device 10 executes processing of setting the measurement conditions to be used in the measurement mode.

Hereinafter, in the flowchart in FIG. 5, description will be provided while the range of the field of view is set as a range of a field of view Pᵢ, and the scanning speed is set as a scanning speed Vₖ. The parameter i is an index for identifying each range of the field of view P, and the parameter k is an index for identifying each scanning speed V.

The operator places the measurement target W to be used in the pre-adjustment mode on the stage 22 and selects the pre-adjustment mode via the operating unit 21. A selection result by the operator is input to the control unit 116, and the control unit 116 controls the whole processing of the pre-adjustment mode.

The operator sets a minimum range of the field of view Pₘᵢₙ (see FIG. 4) and a frame dropping occurrence rate threshold Th₁ based on the measurement target W (step S1). The minimum range of the field of view Pₘᵢₙ means a range of a field of view having a minimum area (a minimum size) to include a region to be measured of the measurement target W therein, in the range of the field of view P of the camera 14. Because the minimum range of the field of view Pₘᵢₙ may include the region to be measured of the measurement target W therein, it is possible to avoid a situation where a plurality of times of measurement are required to measure the measurement target W. The frame dropping occurrence rate threshold Th₁ is compared with the frame dropping occurrence rate FDR in step S5 which will be described later, and it is determined whether or not to change the measurement conditions. The minimum range of the field of view Pₘᵢₙ and the frame dropping occurrence rate threshold Th₁ may be manually or automatically set. Information on the minimum range of the field of view Pₘᵢₙ and the frame dropping occurrence rate threshold Th₁ is input to the measurement condition setting unit 108 of the control device 20. The information on the minimum range of the field of view Pₘᵢₙ and the frame dropping occurrence rate threshold Th₁ may be stored in the storing unit 100.

Then, the measurement condition setting unit 108 sets i=1 for the parameter i indicating the index of the range of the field of view Pᵢ and sets k=1 for the parameter k indicating the index of the scanning speed Vₖ (step S2). Further, the measurement condition setting unit 108 sets a maximum range of the field of view Pₘₐₓ of the camera 14 as the range of the field of view P₁ and sets a maximum scanning speed Vₘₐₓ as the scanning speed V₁, as their initial values. In the flow in FIG. 5, the initial values of the range of the field of view P₁ and the scanning speed V₁ are set under the condition that the measurement efficiency is prioritized.

Then, the measurement control unit 102 controls the optical head unit by the light source unit control unit 120, the imaging instructing unit 122 and the drive unit control unit 124 based on the range of the field of view Pᵢ and the scanning speed Vₖ set by the measurement condition setting unit 108. In the surface shape measuring device 10, the camera 14 acquires a plurality of observation images 36 at respective scanning positions based on the position signal 38 output from the encoder 18 while the optical head 12 is caused to scan. The camera 14 acquires the observation image 36 of the measurement target W, the control device 20 acquires the position signal 38 from the encoder 18, and the measurement ends (step S3). While the observation image 36 and the position signal 38 are acquired, the trigger signal counting unit 112 counts the number of triggers output from the trigger signal output unit 104. The number of triggers counted by the trigger signal counting unit 112 is a value corresponding to the estimated number of frames to be measured M described above. Note that in a case where the sampling interval D_{c} [nm] and the scanning range D_{R} [nm] are acquired or set, for example, the estimated number of frames to be measured may be calculated based on expression (5) by the frame dropping occurrence rate calculating unit 110, or the like. In this case, the trigger signal counting unit 112 is not required. Further, the camera frame counting unit 114 counts the number of the observation images 36 actually acquired by the camera 14 as the number of measured frames N.

Then, the frame dropping occurrence rate calculating unit 110 calculates the frame dropping occurrence rate FDR based on the “estimated number of frames to be measured M” acquired by the trigger signal counting unit 112 and the “number of measured frames N” acquired by the camera frame counting unit 114 (step S4).

Then, the measurement condition setting unit 108 determines whether the frame dropping occurrence rate FDR is equal to or less than the frame dropping occurrence rate threshold Th₁ (FDR≤Th₁) (step S5). In a case where the determination result in step S5 is “Yes”, the measurement condition setting unit 108 determines that the measurement conditions are not required to be changed, stores the range of the field of view Pᵢ and the scanning speed Vₖ at the time when the determination is performed (when FDR≤Th₁) and sets the stored range of the field of view Pᵢ and scanning speed Vₖ as the measurement conditions to be applied in the measurement mode (step S6). Then, the surface shape measuring device 10 ends the pre-adjustment mode.

In a case where the determination result in step S5 is “No” (FDR>Th₁), the measurement condition setting unit 108 determines that the measurement conditions are required to be changed and changes the measurement conditions (step S7). In other words, the measurement condition setting unit 108 indirectly determines that the vibration affects measurement accuracy of the surface shape measuring device 10 under the set measurement conditions.

In the flow in FIG. 5, in a case where it is determined that the measurement conditions are required to be changed, the measurement condition setting unit 108 changes the range of the field of view Pᵢ and the scanning speed Vₖ so that the frame dropping occurrence rate FDR becomes less than the frame dropping occurrence rate threshold Th₁.

While in the flow in FIG. 5, the measurement conditions of both the range of the field of view Pᵢ and the scanning speed Vₖ may be set, the range of the field of view Pᵢ of the camera 14 is changed in preference to the scanning speed Vₖ of the optical head 12. In order to make the frame dropping occurrence rate FDR less than the frame dropping occurrence rate threshold Th₁, it is necessary to make the range of the field of view Pᵢ smaller or make the scanning speed Vₖ lower. In the scanning-type surface shape measuring device 10, the measurement efficiency becomes lower in a case where the scanning speed Vₖ is made lower (changed) than in a case where the range of the field of view Pᵢ is made smaller (changed). Thus, the range of the field of view Pᵢ is preferentially changed.

In step S7, the measurement condition setting unit 108 calculates the range of the field of view Pᵢ+1, for example, in accordance with the following expression (7) and changes the range of the field of view Pᵢ. In step S7, the measurement condition setting unit 108 changes only the range of the field of view Pᵢ.

$$Range of field of view {P}_{i + 1} = range of field of view {P}_{i} \times ( 0.95 - F D R ) \qquad ( 7 )$$

In expression (7), a degree of reducing the range of the field of view Pᵢ changes depending on a value of the frame dropping occurrence rate FDR calculated in step S4. Because the degree of reducing the range of the field of view Pᵢ changes in accordance with the frame dropping occurrence rate FDR, it is less necessary to repeat the same routine of reducing the range a plurality of times than a case where the range of the field of view Pᵢ is simply multiplied by 0.95. This can make setting of the measurement conditions more efficient. While a numerical value of “0.95” is used in expression (7), other numerical values may be used. Further, as indicated in the following expression (8), the degree of reducing the range of the field of view Pᵢ does not have to be changed depending on the value of the frame dropping occurrence rate FDR.

$$Range of field of view {P}_{i + 1} = range of field of view {P}_{i} \times 0.95 \qquad ( 8 )$$

Then, the measurement condition setting unit 108 determines whether the range of the field of view Pᵢ₊₁ is equal to or larger than the minimum range of the field of view Pₘᵢₙ (Pᵢ₊₁≥Pₘᵢₙ) (step S8). In a case where the determination result in step S8 is “Yes”, the measurement condition setting unit 108 increments the parameter i by 1 (step S9). Then, the processing flow proceeds to step S3.

In step S3, the measurement control unit 102 executes measurement of the measurement target W while controlling the optical head unit based on the range of the field of view Pᵢ changed at the measurement condition setting unit 108 and the maintained scanning speed Vₖ.

As long as the relationship of the range of the field of view Pᵢ₊₁≥ the minimum range of the field of view Pₘᵢₙ is satisfied, the processing flow repeats step S3, step S4, step S5, step S7 and step S9 until the relationship of the frame dropping occurrence rate FDR≤ the frame dropping occurrence rate threshold Th₁ is satisfied. In a case where the relationship of the frame dropping occurrence rate FDR≤ the frame dropping occurrence rate threshold Th₁ is satisfied in step S5 (Yes), the processing flow proceeds to step S6. The measurement condition setting unit 108 stores the latest range of the field of view Pᵢ and scanning speed Vₖ at the time when the determination result in step S5 is Yes, and the stored range of the field of view Pᵢ and scanning speed Vₖ are set as the measurement conditions to be applied in the measurement mode.

Then, in a case where the determination result in step S8 is “No”, the measurement condition setting unit 108 determines that the relationship of the frame dropping occurrence rate FDR≤ the frame dropping occurrence rate threshold Th₁ is not satisfied through change of the range of the field of view Pᵢ, ends change of the range of the field of view Pᵢ and changes the scanning speed Vₖ (step S10).

In step S10, the measurement condition setting unit 108 calculates the scanning speed Vₖ+1, for example, in accordance with the following expression (9) and changes the scanning speed Vₖ. In step S10, the measurement condition setting unit 108 changes only the scanning speed Vₖ.

$$Scanning speed {V}_{k + 1} = scanning speed {V}_{k} \times ( 0.95 - F D R ) \qquad ( 9 )$$

In expression (9), in a similar manner to step S7, the degree of reducing the scanning speed Vₖ is changed depending on the value of the frame dropping occurrence rate FDR calculated in step S4. This can make setting of the measurement conditions more efficient. The degree of reducing the scanning speed Vₖ does not have to be changed depending on the value of the frame dropping occurrence rate FDR.

Then, the measurement control unit 102 executes measurement of the measurement target W while controlling the optical head unit based on the range of the field of view Pᵢ+1 changed in step S7 and the scanning speed Vₖ+1 changed in step S10 (step S11).

Then, the frame dropping occurrence rate calculating unit 110 calculates the frame dropping occurrence rate FDR based on the “estimated number of frames to be measured M” (the number of triggers) acquired by the trigger signal counting unit 112 and the “number of measured frames N” acquired by the camera frame counting unit 114 (step S12).

Then, the measurement condition setting unit 108 determines whether the frame dropping occurrence rate FDR is equal to or less than the frame dropping occurrence rate threshold Th₁ (FDR≤Th₁) (step S13).

In a case where the determination result in step S13 is “No” (FDR>Th₁), it is determined that the measurement conditions are required to be changed, and the parameter k is incremented by 1 (step S14). Then, the processing flow proceeds to step S10. The processing flow repeats step S10, step S11, step S12, step S13 and step S14 until the relationship of the frame dropping occurrence rate FDR≤ the frame dropping occurrence rate threshold Th₁ is satisfied.

In a case where the relationship of the frame dropping occurrence rate FDR≤ the frame dropping occurrence rate threshold Th₁ is satisfied in step S13 (in a case of Yes), the processing flow proceeds to step S6, the latest range of the field of view Pᵢ and the latest scanning speed Vₖ are stored, and the stored range of the field of view Pᵢ and scanning speed Vₖ are set as the measurement conditions to be applied in the measurement mode.

As described above, the surface shape measuring device 10 starts the pre-adjustment mode while setting the maximum range of the field of view Pₘₐₓ as the initial range of the field of view P₁ and setting the maximum scanning speed Vₘₐₓ as the initial scanning speed V₁. The surface shape measuring device 10 sets the range of the field of view Pᵢ and the scanning speed Vₖ to be used in the measurement mode based on the frame dropping occurrence rate FDR, so that it is possible to suppress degradation in the measurement efficiency and degradation in the measurement accuracy in the measurement mode.

### <Measurement Mode According to First Embodiment>

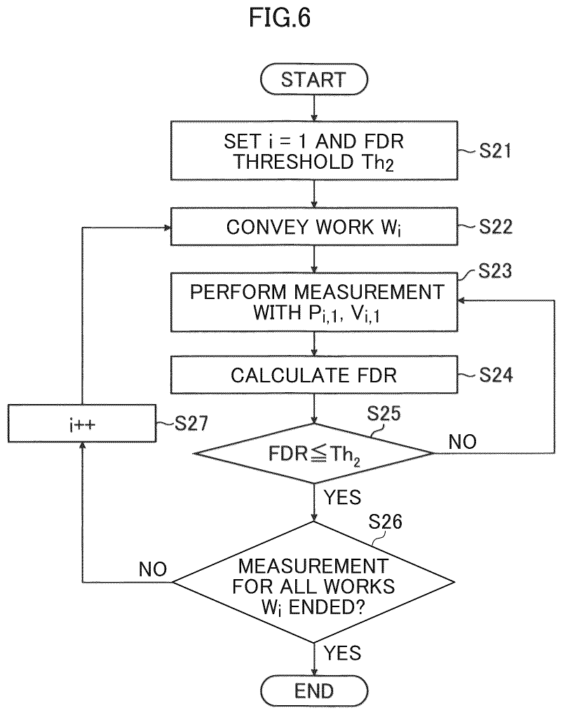

FIG. 6 is a flowchart indicating the measurement mode according to the first embodiment. In the measurement mode according to the first embodiment, the surface shape measuring device 10 determines whether or not re-measurement is required based on the frame dropping occurrence rate FDR, and in a case where it is determined that re-measurement is required, re-measures (retries measurement of) the measurement target W without changing the measurement conditions.

The operator places a work Wᵢ to be used in the measurement mode on the stage 22 and selects the measurement mode from the operating unit 21. A selection result by the operator is input to the control unit 116, and the control unit 116 controls the whole processing of the measurement mode. If the measurement mode is selected, the range of the field of view P and the scanning speed V set in the pre-adjustment mode are set as the range of the field of view P₁ and the scanning speed V₁ as the initial measurement conditions in the measurement mode.

The measurement condition setting unit 108 sets i=1 for the parameter i indicating the index of the work Wᵢ and sets a frame dropping occurrence rate threshold Th₂ in the measurement mode by operation of the operator (step S21). The frame dropping occurrence rate threshold Th₂ in the measurement mode may be the same as or different from the frame dropping occurrence rate threshold Th₁ in the pre-adjustment mode. In a case where the frame dropping occurrence rate threshold Th₂ is less than the frame dropping occurrence rate threshold Th₁, the surface shape measuring device 10 can reduce a risk of retry.

Then, the stage driving unit control unit 126 controls the stage driving unit 24, and the stage driving unit 24 moves the work Wᵢ to the range of the field of view P₁ of the camera 14 (step S22).

Then, the measurement control unit 102 controls the optical head unit by the light source unit control unit 120, the imaging instructing unit 122 and the drive unit control unit 124 based on the range of the field of view P_{i,1} and the scanning speed V_{i,1} set by the measurement condition setting unit 108. In the surface shape measuring device 10, the camera 14 acquires the observation images 36 at the respective scanning positions based on the position signal 38 output from the encoder 18 while the optical head 12 is caused to scan. The camera 14 acquires the observation image 36 of the work Wᵢ, and the control device 20 acquires the position signal 38 of the work Wᵢ from the encoder 18, and the measurement ends (step S23). The range of the field of view P_{i,1} means measurement for the i-th work Wᵢ in the initially set range of the field of view P_{i,1}. The scanning speed V_{i,1} means measurement for the i-th work Wᵢ at the initially set scanning speed V₁. While the observation image 36 and the position signal 38 are acquired, the trigger signal counting unit 112 counts the number of triggers output by the trigger signal output unit 104. Further, the camera frame counting unit 114 counts the number of measured frames N.

Then, the frame dropping occurrence rate calculating unit 110 calculates the frame dropping occurrence rate FDR based on the “estimated number of frames to be measured M” (the number of triggers) acquired by the trigger signal counting unit 112 and the “number of measured frames N” acquired by the camera frame counting unit 114 (step S24).

Then, the measurement condition setting unit 108 determines whether the frame dropping occurrence rate FDR is equal to or less than the frame dropping occurrence rate threshold Th₂ (FDR≤Th₂) (step S25).

In a case where the determination result in step S25 is “No” (FDR>Th₂), the measurement condition setting unit 108 determines that re-measurement is required. In other words, the measurement condition setting unit 108 indirectly determines that the vibration affects measurement by the surface shape measuring device 10 under the set measurement conditions. The processing flow proceeds to step S23, and the measurement control unit 102 executes measurement for the work Wᵢ while controlling the optical head unit based on the range of the field of view P_{i,1} and the scanning speed V_{i,1}. The processing flow repeats step S23, step S24 and step S25 until the relationship of the frame dropping occurrence rate FDR≤ the frame dropping occurrence rate threshold Th₂ is satisfied.

Then, in a case where the determination result in step S25 is “Yes”, the control unit 116 determines whether or not measurement is completed for all of the works Wᵢ (step S26).

In a case where the determination result in step S26 is “No”, the control unit 116 increments the parameter i by 1 (step S27). Then, the processing flow proceeds to step S22.

The processing flow repeats step S22, step S23, step S24, step S25 and step S26 until measurement is completed for all the works Wᵢ.

Then, in a case where the determination result in step S26 is “Yes”, the surface shape measuring device 10 ends measurement for the works Wᵢ.

In the measurement mode according to the first embodiment, it is determined that the frame dropping occurrence rate FDR incidentally becomes greater than the frame dropping occurrence rate threshold Th₂, and the surface shape measuring device 10 performs re-measurement without changing the initial measurement conditions (the range of the field of view P₁ and the scanning speed V₁). Because the measurement conditions are not changed, degradation of the measurement efficiency can be suppressed.

### Second Embodiment

A second embodiment will be described next. In the second embodiment, while the pre-adjustment mode is the same as the pre-adjustment mode in the first embodiment, the measurement mode is different from the measurement mode in the first embodiment.

### <Measurement Mode According to Second Embodiment>

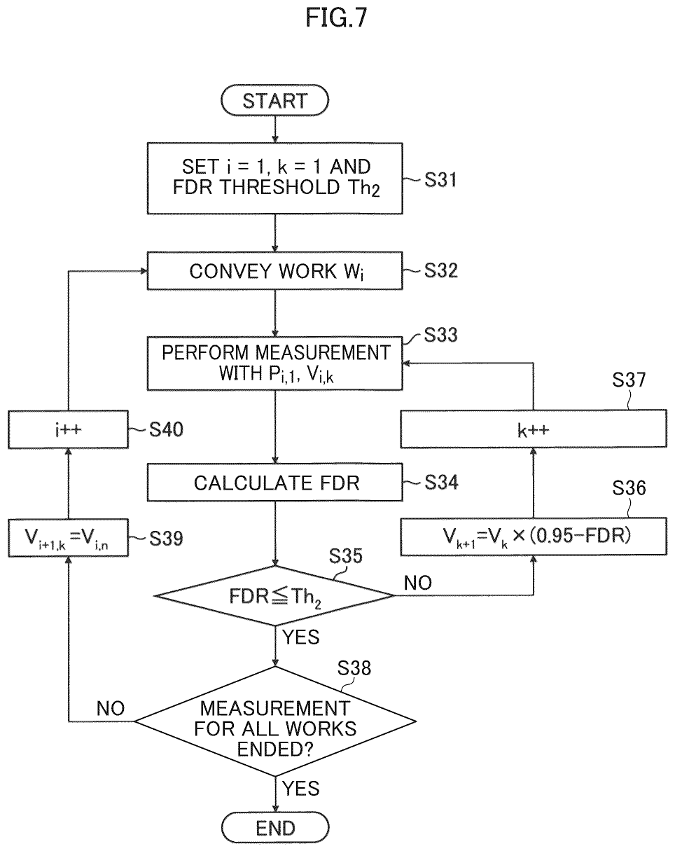

The measurement mode according to the second embodiment will be described below using FIG. 7. As indicated in FIG. 7, in the measurement mode according to the second embodiment, the surface shape measuring device 10 determines whether or not the measurement conditions are required to be changed based on the frame dropping occurrence rate FDR, and in a case where it is determined that the measurement conditions are required to be changed, re-measures (retries measurement of) the measurement target W while changing the measurement conditions.

The operator places the work Wᵢ to be used in the measurement mode on the stage 22 and selects the measurement mode via the operating unit 21. A selection result by the operator is input to the control unit 116, and the control unit 116 controls the whole processing of the measurement mode. If the measurement mode is selected, the range of the field of view P and the scanning speed V set in the pre-adjustment mode are set as the range of the field of view P₁ and the scanning speed V₁ as the initial measurement conditions in the measurement mode.

The measurement condition setting unit 108 sets i=1 for the parameter i indicating the index of the work Wᵢ, sets k=1 for the parameter k indicating the index of the scanning speed Vₖ and sets the frame dropping occurrence rate threshold Th₂ in the measurement mode by operation of the operator (step S31). In a similar manner to the first embodiment, the frame dropping occurrence rate threshold Th₂ in the measurement mode may be the same as or different from the frame dropping occurrence rate threshold Th₁ in the pre-adjustment mode.

Then, the stage driving unit control unit 126 controls the stage driving unit 24, and the stage driving unit 24 moves the work Wᵢ to the range of the field of view P₁ of the camera 14 (step S32).

Then, the measurement control unit 102 controls the optical head unit by the light source unit control unit 120, the imaging instructing unit 122 and the drive unit control unit 124 based on the range of the field of view P_{i,1} and the scanning speed V_{i,1} set by the measurement condition setting unit 108. In the surface shape measuring device 10, the camera 14 acquires the observation images 36 at the respective scanning positions based on the position signal 38 output from the encoder 18 while the optical head 12 is caused to scan. The camera 14 acquires the observation image 36 of the work Wᵢ, the control device 20 acquires the position signal 38 from the encoder 18, and the measurement ends (step S33). While the observation image 36 and the position signal 38 are acquired, the trigger signal counting unit 112 counts the number of triggers output from the trigger signal output unit 104. Further, the camera frame counting unit 114 counts the number of measured frames N.

Then, the frame dropping occurrence rate calculating unit 110 calculates the frame dropping occurrence rate FDR based on the “estimated number of frames to be measured M” (the number of triggers) acquired by the trigger signal counting unit 112 and the “number of measured frames N” acquired by the camera frame counting unit 114 (step S34).

Then, the measurement condition setting unit 108 determines whether the frame dropping occurrence rate FDR is equal to or less than the frame dropping occurrence rate threshold Th₂ (FDR≤ Th₂) (step S35).

In a case where the determination result in step S35 is “No” (FDR>Th₂), the measurement condition setting unit 108 determines that the measurement conditions are required to be changed for re-measurement, and the measurement condition setting unit 108 changes the measurement conditions (step S36). In other words, the measurement condition setting unit 108 indirectly determines that the vibration affects the measurement accuracy of the surface shape measuring device 10 under the set measurement conditions.

In a case where it is determined that the measurement conditions are required to be changed, the measurement condition setting unit 108 reduces the scanning speed Vₖ of the optical head 12 so that the frame dropping occurrence rate FDR becomes less than the frame dropping occurrence rate threshold Th₂.

In step S36, the measurement condition setting unit 108 calculates the scanning speed Vₖ₊₁, for example, in accordance with expression (9) and changes the scanning speed Vₖ. In step S36, the measurement condition setting unit 108 changes only the scanning speed Vₖ.

Then, the measurement condition setting unit 108 increments the parameter k by 1 (step S37). Then, the processing flow proceeds to step S33.

The processing flow proceeds to step S33, and the measurement control unit 102 executes measurement of the work Wᵢ while controlling the optical head unit based on the range of the field of view P_{i,1} and the changed scanning speed V_{i,k}. The processing flow repeats step S33, step S34, step S35, step S36 and step S37 until the relationship of the frame dropping occurrence rate FDR≤ the frame dropping occurrence rate threshold Th₂ is satisfied.

Then, in a case where the determination result in step S35 is “Yes”, the control unit 116 determines whether or not measurement of all the works Wᵢ has ended (step S38).

In a case where the determination result in step S38 is “No”, the measurement condition setting unit 108 changes the initial scanning speed V_{i+1,1} for the (i+1)-th work to V_{i,n} (the i-th latest scanning speed) (step S39). Then, the control unit 116 increments the parameter i by 1 (step S40). Then, the processing flow proceeds to step S32. Note that Although the scanning sped V_{i+1,1} is set to be V_{i+1,1}=Vin in step S39, the scanning speed V_{i,n} may become lower due to incidental vibration such as, for example, an earthquake. Thus, preferably, the scanning speed is returned to the initial scanning speed V_{i,1},for example, once every time the work W is measured ten times.

The processing flow repeats step S32, step S33, step S34, step S35, step S36, step S37, step S38, step S39 and step S40 until measurement for all the works Wᵢ is completed.

Then, in a case where the determination result in step S38 is “Yes”, the surface shape measuring device 10 ends measurement of the work Wᵢ.

In the measurement mode according to the second embodiment, the surface shape measuring device 10 determines that the frame dropping occurrence rate FDR becomes greater than the frame dropping occurrence rate threshold Th₂ due to influence of the vibration, and the surface shape measuring device 10 changes the scanning speed Vₖ in the initial measurement conditions and performs re-measurement. By performing re-measurement while changing the measurement conditions, influence of the vibration can be eliminated, so that it is possible to prevent degradation of the measurement accuracy.

### Third Embodiment

A third embodiment will be described next. In the third embodiment, measurement targets W are directly or indirectly placed on the stage 22, and measurement is performed at positions of the respective measurement targets W while moving the stage 22. Thus, the third embodiment is different from the first embodiment in that the measurement conditions are set for each position of the stage 22 in the pre-adjustment mode, and that measurement is performed using the measurement conditions set for each position of the stage 22 in the measurement mode. Calculation of the three-dimensional shape of the measurement target W by the surface shape measuring device 10 is the same as that in the first embodiment. Points different from the first embodiment will be described below.

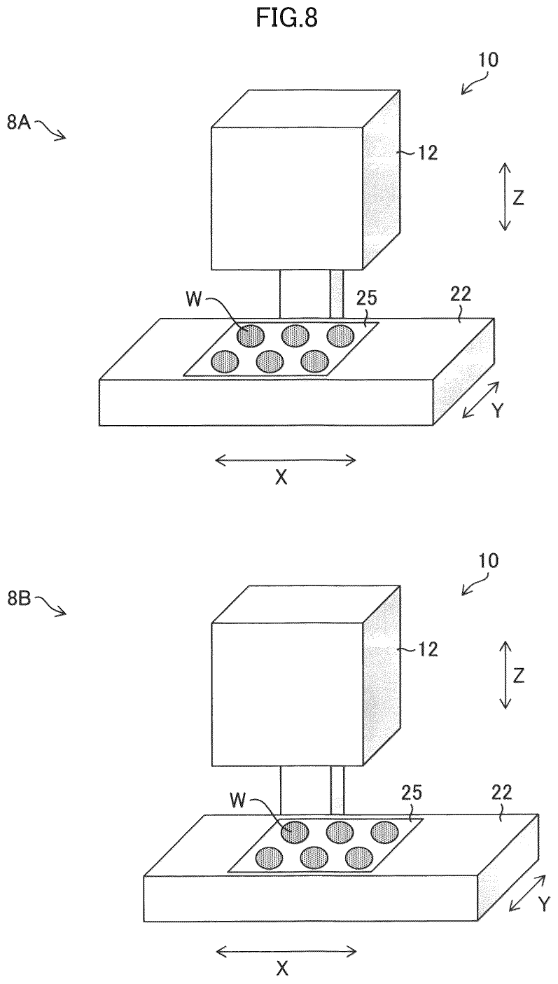

First, measurement of the measurement targets W will be described with reference to FIG. 8. As illustrated in FIG. 8, measurement targets W are placed on one pallet 25. The pallet 25 on which the measurement targets W are placed is support by the stage 22. The stage 22 is configured to be movable in two axes parallel to the X direction and the Y direction.

In a reference numeral 8A in FIG. 8, one of the measurement targets W is selected as a measurement target, and the measurement target W is moved in a plane of the stage 22 to be aligned with the optical head 12. The surface shape measuring device 10 measures the surface shape of the measurement target W.

In a reference numeral 8B in FIG. 8, a measurement target W different from that in the reference numeral 8A is selected as the measurement target, and the measurement target W is moved in a plane of the stage 22 to be aligned with the optical head 12. The surface shape measuring device 10 measures the surface shape of the measurement target W different from that in the reference numeral 8A. Measurement targets W of the same type are measured by the surface shape measuring device 10.

FIG. 8 illustrates an example where measurement targets W are placed on the pallet 25. However, the measurement target W is not limited to this. For example, a semiconductor wafer and circuit patterns formed on the semiconductor wafer can be used as measurement targets of the same type. The semiconductor wafer can correspond to the pallet, and the circuit patterns can correspond to the measurement targets W.

Further, FIG. 8 illustrates an example of a case where the stage 22 is movable in two axes of the X direction and the Y direction. However, the stage 22 may be movable in one axis of the X direction or the Y direction, or the stage 22 may be movable in three axes of the X direction, the Y direction and the Z direction or may be movable in more axes. While a case has been described where the stage 22 is moved, the optical head 12 may be moved if the optical head 12 and the stage 22 can be relatively moved.

As illustrated in FIG. 8, in a case where measurement targets W are measured, the optical head 12 and the stage 22 are relatively moved and positioned. Thus, as indicated in the reference numeral 8A and the reference numeral 8B, a relative positional relationship between the optical head 12 and the stage 22 is different depending on the position of the measurement target W. When viewed the optical head 12 and the stage 22 as one system including them therein, a center of gravity of the system is different between the reference numeral 8A and the reference numeral 8B. Ease of vibration changes for each position of the stage 22 (for each position of the measurement target W) due to a difference in the position of the center of gravity.

Thus, in a case where the measurement conditions are set, the measurement conditions are set based on the frame dropping occurrence rate FDR and also the measurement conditions are set for each position of the stage 22, so that the surface shape measuring device 10 can more reliably suppress degradation of the measurement accuracy.

### <Pre-Adjustment Mode According to Third Embodiment>

In the pre-adjustment mode according to the third embodiment, if the measurement conditions are set for a certain stage position, the stage 22 is moved to another position, and the measurement conditions are set for the other position. Finally, the measurement conditions to be used in the measurement mode are set for each of all the positions of the stage 22.

Note that as described with expression (4), in a case where the scanning speed V_{c} is high, or in a case where the range of the field of view P is large, frame dropping is likely to occur. Thus, in the pre-adjustment mode, both the range of the field of view P and the scanning speed V_{c} are set as the measurement conditions for each position of the stage 22.

To set the measurement conditions, the pallet 25 on which the measurement target W to be measured is placed is installed as advance preparation. As described above, the position of the center of gravity changes, and ease of vibration changes depending on the position of the stage 22. The surface shape measuring device 10 performs measurement while changing the position of the stage 22 to positions in the X direction or in the Y direction and calculates a frame dropping occurrence rate at each of the positions of the stage 22.

For example, in a case where description will be provided using the X axis as an example, it is assumed that the stage 22 can be moved from 0 to X₁. A portion from 0 to X₁ is divided into four portions, and five portions of 0, X₁/4, 2X₁/4, 3X₁/4 and X₁ are determined as portions for which the measurement conditions are set. The range of the field of view P and the scanning speed V are measured at a position of each determined set portion, and a measurement condition map as indicated in the following Table 1 is created and stored. Indexes in the ranges of the field of view P₀, P₁, P₂, P₃ and P₄ and the scanning speeds V₀, V₁, V₂, V₃ and V₄ mean the ranges of the field of view and the scanning speeds at the respective positions. The ranges of the field of view P₀, P₁, P₂, P₃ and P₄ may be the same as the range of the field of view, or may be different from the range of the field of view. In a similar manner, the scanning speeds V₀, V₁, V₂, V₃ and V₄ may be the same scanning speed or may be different scanning speeds from each other.

TABLE 1

| Position | Range of field of view P | Scanning speed V |
|---|---|---|
| 0 | P₀ | V₀ |
| X₁/4 | P₁ | V₁ |
| 2X₁/4 | P₂ | V₂ |
| 3X₁/4 | P₃ | V₃ |
| X₁ | P₄ | V₄ |

In the measurement mode, the surface shape measuring device 10 measures the surface shape of the measurement target W with the measurement conditions (map indicated in Table 1) set for each position of the stage 22. Note that in a case of measurement of the measurement target W located at a position on the stage 22 not present in the map, the measurement may be performed while estimating the measurement conditions through linear interpolation, or the like.

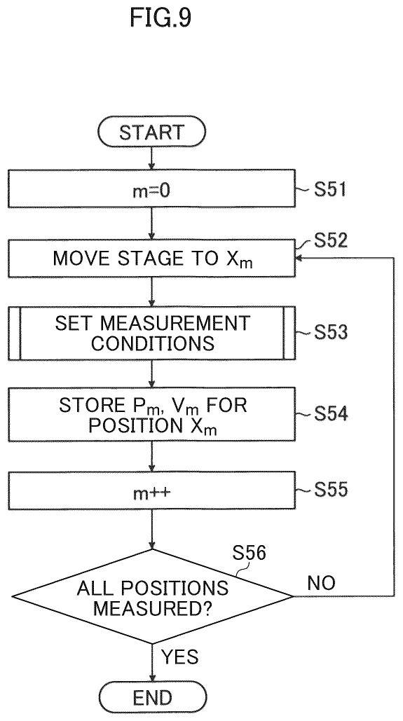

Setting of the measurement conditions in the pre-adjustment mode according to the third embodiment will be described next using FIG. 9. Description will be provided assuming that a portion of the stage 22 for which the measurement conditions should be set is a position Xₘ, the range of the field of view is the range of the field of view Pᵢ, and the scanning speed is the scanning speed Vₖ. The parameter m is an index for identifying each position m, the parameter i is an index for identifying each range of the field of view P, and the parameter k is an index for identifying each scanning speed V.

The operator places measurement targets W to be used in the pre-adjustment mode on the stage 22 and selects the pre-adjustment mode from the operating unit 21. A selection result by the operator is input to the control unit 116, and the control unit 116 controls the whole processing of the pre-adjustment mode.

m=0 is set for the parameter m indicating the index of the position Xₘ (step S51). Then, the stage is moved to the position Xₘ (step S52). Then, the surface shape measuring device 10 executes processing of setting the measurement conditions for the position Xₘ (step S53). The processing of setting the measurement conditions in step S53 is similar to the processing described using FIG. 5 in the first embodiment, and thus, description will be omitted.

Note that step S1 indicated in FIG. 5 may be performed in step S51 indicated in FIG. 9. Further, if setting is performed once in the pre-adjustment mode, it is not necessary to change the minimum range of the field of view Pₘᵢₙ and the frame dropping occurrence rate threshold Th₁ until the pre-adjustment mode ends.

After step S53 ends, the latest range of the field of view and the latest scanning speed set in step S53 are stored as the range of the field of view Pₘ and the scanning speed Vₘ in association with the position Xₘ (step S54).

The control unit 116 increments the parameter m by 1 (step S55) and determines whether or not setting of the measurement conditions has ended for all the positions (step S56). In a case where the determination result in step S6 is “No”, the processing flow proceeds to step S52. The processing flow repeats step S52, step S53, step S54 and step S55 until setting of the measurement conditions ends for all the positions.

In a case where the determination result in step S56 is “Yes”, the pre-adjustment mode ends. When the pre-adjustment mode ends, the surface shape measuring device 10 creates a map in which the position X, the range of the field of view P and the scanning speed V are associated with each other as indicated in Table 1 and stores the map in the storing unit 100.

As described above, the surface shape measuring device 10 starts the pre-adjustment mode while setting the maximum range of the field of view Pₘₐₓ as the initial range of the field of view P₁ and setting the maximum scanning speed Vₘₐₓ as the initial scanning speed V₁. The surface shape measuring device 10 sets the range of the field of view Pₘ and the scanning speed Vₘ to be used in the measurement mode for each position Xₘ based on the frame dropping occurrence rate FDR, so that degradation of the measurement accuracy in the measurement mode can be suppressed.

### <Measurement Mode According to Third Embodiment>

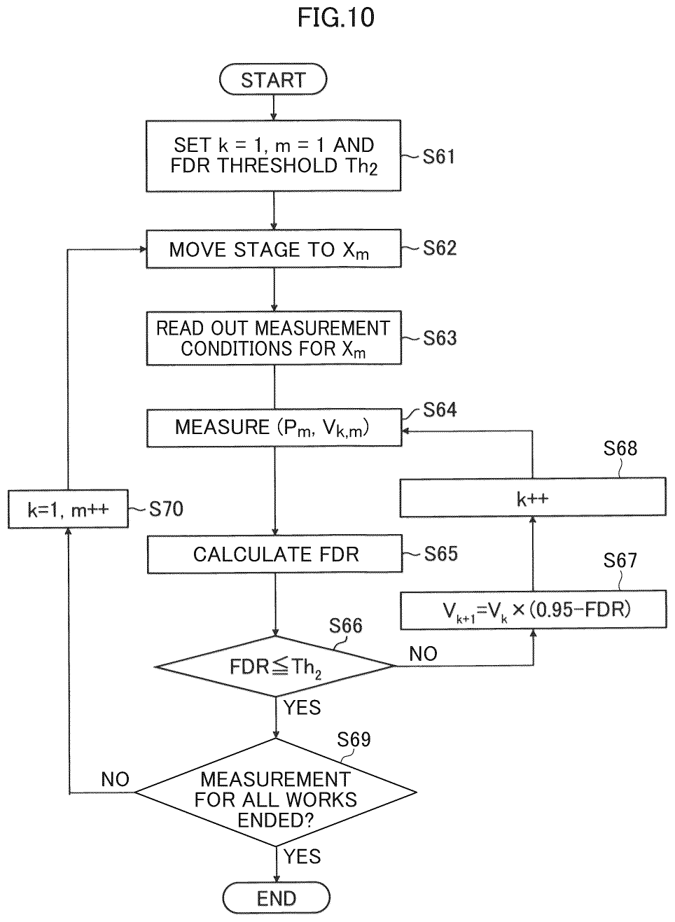

The measurement mode according to the third embodiment will be described next with reference to FIG. 10. In the measurement mode, the surface shape measuring device 10 performs measurement based on the measurement conditions stored for each position of the stage 22, determines whether or not the measurement conditions are required to be changed based on the frame dropping occurrence rate FDR, and in a case where it is determined that the measurement conditions are required to be changed, re-measures (retries measurement of) the measurement target (work) W while changing the measurement conditions.

The operator places works W to be used in the measurement mode at a predetermined position X on the stage 22 and selects the measurement mode from the operating unit 21. A selection result by the operator is input to the control unit 116, and the control unit 116 controls the whole processing of the measurement mode.

The measurement condition setting unit 108 sets k=1 for the parameter k indicating the index of the scanning speed Vₖ, sets m=1 for the parameter m indicating the index of the position Xₘ and sets the frame dropping occurrence rate threshold Th₂ in the measurement mode by the operation of the operator (step S61). The frame dropping occurrence rate threshold Th₂ in the measurement mode may be the same as or different from the frame dropping occurrence rate threshold Th₁ in the pre-adjustment mode. In a case where the frame dropping occurrence rate threshold Th₂ is less than the frame dropping occurrence rate threshold Th₁, the surface shape measuring device 10 may reduce a risk of retry.

Then, the stage driving unit control unit 126 controls the stage driving unit 24 and moves the work Wₘ located at the position Xₘ on the stage 22 to a position facing the optical head 12 (step S62).

Then, the measurement control unit 102 reads out the measurement conditions (the range of the field of view Pₘ, the scanning speed V_{k,m}) corresponding to the position Xₘ set by the measurement condition setting unit 108, for example, from the map stored in the storing unit 100 (step S63). The range of the field of view Pₘ is a range of a field of view at the position Xₘ, and the scanning speed V_{k,m} is a scanning speed at the position X_{m,k} is a counter when the scanning speed Vₘ is repeatedly changed.

Then, the measurement control unit 102 controls the optical head unit by the light source unit control unit 120, the imaging instructing unit 122 and the drive unit control unit 124 based on the read out measurement conditions (the range of the field of view Pₘ, the scanning speed V_{k,m}). The camera 14 acquires the observation image 36 of the work Wₘ, the control device 20 acquires the position signal 38 from the encoder 18, and the measurement ends (step S64). While the observation image 36 and the position signal 38 are acquired, the trigger signal counting unit 112 counts the number of triggers output from the trigger signal output unit 104. Further, the camera frame counting unit 114 counts the number of measured frames N.

Then, the frame dropping occurrence rate calculating unit 110 calculates the frame dropping occurrence rate FDR based on the “estimated number of frames to be measured M” acquired by the trigger signal counting unit 112 and the “number of measured frames N” acquired by the camera frame counting unit 114 (step S65).

Then, the measurement condition setting unit 108 determines whether the frame dropping occurrence rate FDR is equal to or less than the frame dropping occurrence rate threshold Th₂ (FDR≤Th₂) (step S66).

In a case where the determination result in step S66 is “No” (FDR>Th₂), the measurement condition setting unit 108 determines that the measurement conditions are required to be changed for re-measurement, and the measurement condition setting unit 108 changes the measurement conditions (step S67). In other words, the measurement condition setting unit 108 indirectly determines that the vibration affects the measurement accuracy of the surface shape measuring device 10 with the set measurement conditions.

In a case where it is determined that the measurement conditions are required to be changed, the measurement condition setting unit 108 makes the scanning speed V_{k,m} of the optical head 12 lower so that the frame dropping occurrence rate FDR becomes less than the frame dropping occurrence rate threshold Th₂.

In step S67, the measurement condition setting unit 108 calculates the scanning speed Vₖ₊₁, for example, in accordance with expression (9) and changes the scanning speed Vₖ.

Then, the measurement condition setting unit 108 increments the parameter k by 1 (step S68). Then, the processing flow proceeds to step S64, and the work Wₘ is re-measured.

Thereafter, in the measurement control unit 102, the processing flow repeats step S64, step S65, step S66, step S67 and step S68 until the relationship of the frame dropping occurrence rate FDR≤ the frame dropping occurrence rate threshold Th₂ is satisfied.

Then, in a case where the determination result in step S66 is “Yes”, the control unit 116 determines whether or not measurement of all the works Wₘ has ended (step S69).

In a case where the determination result in step S69 is “No”, the control unit 116 increments the parameter m by 1, and the measurement condition setting unit 108 sets k=1 for the parameter k (step S70). Then, the processing flow proceeds to step S62.

The processing flow repeats step S62, step S63, step S64, step S65, step S66, step S67 step S68, step S69 and step S70 until measurement of all the works Wₘ ends.

Then, in a case where the determination result in step S69 is “Yes”, the surface shape measuring device 10 ends measurement of the work Wₘ.

According to the third embodiment, the measurement conditions are set for each position of the stage 22 in the pre-adjustment mode, so that in the measurement mode, even if a relative positional relationship between the optical head 12 and the stage 22 changes, the measurement accuracy is less affected by the vibration. This results in making it possible to suppress degradation of the measurement accuracy. Further, in a case where the frame dropping occurrence rate FDR>the frame dropping occurrence rate threshold Th₂, it is determined that the vibration affects the measurement accuracy, and re-measurement is performed while changing the scanning speed Vₖ among the initial measurement conditions for each position Xₘ. By performing re-measurement while changing the measurement conditions, influence of the vibration can be eliminated, so that it is possible to prevent degradation of the measurement accuracy.

### Other Modifications

While a case has been described from the first embodiment to the third embodiment where the optical head 12 is a Michelson-type white light interferometry microscope, the optical head 12 may be a Mirau-type white light interferometry microscope or may be a Linic-type white light interferometry microscope. Further, the optical head 12 may be a focus variation-type microscope.

While an example has been described where the surface shape measuring device 10 changes the scanning speed V in the measurement mode according to the second embodiment and the third embodiment, the range of the field of view P may be changed instead of the scanning speed V. Further, the surface shape measuring device 10 may change the range of the field of view P and the scanning speed V.

### REFERENCE SIGNS LIST

10 . . . Surface shape measuring device, 12 . . . Optical head, 14 . . . Camera, 16 . . . Drive unit, 18 . . . Encoder, 20 . . . Control device, 21 . . . Operating unit, 22 . . . Stage, 23 . . . Display unit, 24 . . . Stage driving unit, 25 . . . Pallet, 26 . . . Light source unit, 28 . . . Beam splitter, 30 . . . Interference objective lens, 30A . . . Objective lens, 30B . . . Beam splitter, 30C . . . Reference surface, 32 . . . Imaging lens, 36 . . . Observation image, 38 . . . Position signal, 100 . . . Storing unit, 102 . . . Measurement control unit, 104 . . . Trigger signal output unit, 106 . . . Three-dimensional shape calculating unit, 108 . . . Measurement condition setting unit, 110 . . . Frame dropping occurrence rate calculating unit, 112 . . . Trigger signal counting unit, 114 . . . camera frame counting unit, 116 . . . Control unit, 120 . . . Light source unit control unit, 122 . . . Imaging instructing unit, 124 . . . Drive unit control unit, 126 . . . Stage driving unit control unit, L1 . . . Measurement light, L2 . . . Reference light, L3 . . . Multiplexed light, W . . . Measurement target

What is claimed is:

1. A surface shape measuring device that acquires an observation image of a measurement target while causing an optical head to scan relatively to the measurement target in a direction perpendicular to the measurement target, the surface shape measuring device comprising:
a camera configured to capture the observation image acquired by the optical head;
a drive unit configured to cause the optical head to scan relatively to the measurement target in a scanning direction perpendicular to the measurement target;
an encoder configured to detect a position of the optical head in the scanning direction with respect to the measurement target;
an imaging instructing unit configured to instruct the camera to capture the observation image based on a position signal output from the encoder for each predetermined interval;
a frame dropping occurrence rate calculating unit configured to calculate a frame dropping occurrence rate indicating an occurrence rate of frame dropping of the camera; and
a measurement condition setting unit configured to set a measurement condition for measuring a surface shape of the measurement target based on the frame dropping occurrence rate.

2. The surface shape measuring device according to claim 1, further comprising:
a stage configured to move the measurement target relatively to the optical head, wherein
the frame dropping occurrence rate calculating unit calculates the frame dropping occurrence rate indicating the occurrence rate of frame dropping of the camera for each position of the stage, and
the measurement condition setting unit sets the measurement condition for measuring the surface shape of the measurement target for each position of the stage based on the frame dropping occurrence rate.

3. The surface shape measuring device according to claim 1, wherein
the measurement condition setting unit sets a range of a field of view of the camera as the measurement condition.

4. The surface shape measuring device according to claim 1, wherein
the measurement condition setting unit sets a scanning speed of the optical head with respect to the measurement target as the measurement condition.

5. The surface shape measuring device according to claim 1, wherein
the measurement condition setting unit determines whether or not the measurement condition is required to be changed based on a result of comparing the frame dropping occurrence rate with a frame dropping occurrence rate threshold.

6. The surface shape measuring device according to claim 5, wherein
in a case where it is determined that the measurement condition is required to be changed, the measurement condition setting unit changes the measurement condition so that the frame dropping occurrence rate becomes less than the frame dropping occurrence rate threshold.

7. The surface shape measuring device according to claim 6, wherein
the measurement condition setting unit can set both the range of the field of view of the camera and the scanning speed of the optical head with respect to the measurement target as the measurement condition, and
in a case where it is determined that the measurement condition is required to be changed, the measurement condition setting unit changes the range of the field of view of the camera in preference to the scanning speed of the optical head so that the frame dropping occurrence rate becomes equal to or less than the frame dropping occurrence rate threshold.

8. The surface shape measuring device according to claim 1, wherein
in a case where the frame dropping occurrence rate is denoted as FDR, the number of frames of the observation image actually captured by the camera is denoted as N, and an estimated number of frames of the observation image to be originally captured by the camera based on the position signal is denoted as M, the frame dropping occurrence rate calculating unit calculates the frame dropping occurrence rate using a following expression:
$$F D R = 1 - N / M .$$

9. The surface shape measuring device according to claim 1, wherein
the optical head is a white light interferometry microscope.

10. A surface shape measurement method for measuring a surface shape by a surface shape measuring device including:
a camera configured to capture an observation image of a measurement target acquired by an optical head;
a drive unit configured to cause the optical head to scan relatively to the measurement target in a scanning direction perpendicular to the measurement target;
an encoder configured to detect a position of the optical head in the scanning direction with respect to the measurement target; and
an imaging instructing unit configured to instruct the camera to capture the observation image based on a position signal output from the encoder for each predetermined interval, the surface shape measurement method comprising:
calculating a frame dropping occurrence rate indicating an occurrence rate of frame dropping of the camera; and
setting a measurement condition for measuring a surface shape of the measurement target based on the frame dropping occurrence rate.

11. The surface shape measurement method according to claim 10, wherein
in the calculation of the frame dropping occurrence rate, the frame dropping occurrence rate indicating the occurrence rate of frame dropping of the camera is calculated for each position of a stage configured to move the measurement target relatively to the optical head, and
in the setting of the measurement condition, the measurement condition for measuring the surface shape of the measurement target is set for each position of the stage based on the frame dropping occurrence rate.

12. The surface shape measurement method according to claim 10, wherein
in the setting of the measurement condition, a range of a field of view of the camera is set as the measurement condition.

13. The surface shape measurement method according to claim 10, wherein
in the setting of the measurement condition, a scanning speed of the optical head with respect to the measurement target is set as the measurement condition.

14. The surface shape measurement method according to claim 10, wherein
in the setting of the measurement condition, whether or not the measurement condition is required to be changed is determined based on a result of comparing the frame dropping occurrence rate with a frame dropping occurrence rate threshold.

15. The surface shape measurement method according to claim 14, wherein
in the setting of the measurement condition, in a case where it is determined that the measurement condition is required to be changed, the measurement condition is changed so that the frame dropping occurrence rate becomes less than the frame dropping occurrence rate threshold.

16. The surface shape measurement method according to claim 15, wherein
in the setting of the measurement condition, both the range of the field of view of the camera and the scanning speed of the optical head with respect to the measurement target can be set as the measurement condition, and in a case where it is determined that the measurement condition is required to be changed, the range of the field of view of the camera is changed in preference to the scanning speed of the optical head so that the frame dropping occurrence rate becomes equal to or less than the frame dropping occurrence rate threshold.

17. The surface shape measurement method according to claim 10, wherein
in a case where the frame dropping occurrence rate is denoted as FDR, the number of frames of the observation image actually captured by the camera is denoted as N, and an estimated number of frames of the observation image to be originally captured by the camera based on the position signal is denoted as M, in the calculation of the frame dropping occurrence rate, the frame dropping occurrence rate is calculated using a following expression:
$$F D R = 1 - N / M .$$
